(19) United States
(12) Patent Application Publication
(10) Pub. No.: US 2009/0175145 A1
(43) Pub. Date: Jul. 9, 2009

(54) FORWARD SENSE SIGNAL GENERATION

(75) Inventor: James Joseph Anthony McCormack, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/304,779

(22) PCT Filed: Jun. 5, 2007
(86) PCT No.: PCT/IB07/52099

§ 371 Date: Dec. 15, 2008

(30) Foreign Application Priority Data
Jun. 15, 2006 (EP) 06115553.7

(51) Int. Cl. G11B 7/12

(52) U.S. Cl. 369/47.51; G9B/7.097

(57) ABSTRACT

A device for recording information on a record carrier (4) has a radiation source and a sensor (33) for generating a sense signal (32), a power control unit (29) for setting the radiation power based on a sampled sense signal, and a sense unit (31) for generating the sampled sense signal. The sense signal is sampled at Ts in periods that are selected on having at least a selected minimum length Lsel in a end part of the selected periods. The sense signal is sampled in the selected control periods for determining a second sample value on a detection time Tdet different from Ts. A difference is determined between the first and the second sample value, and, in dependence on the difference, generating the sampled sense signal is adapted. In particular Lsel may be adapted in dependence on the difference for eliminating remaining effects of a preceding period at a higher power.

The invention relates to a device for scanning a record carrier having a track for recording information represented by marks, the device comprising scanning means comprising a radiation source and optical elements for generating a beam of radiation from the radiation source via a scanning spot on the track to a detector for detecting at least one scanning signal, a sensor for generating a sense signal from the beam, and power control means for setting the radiation power in a sequence of control periods of different lengths, each control period having one of a number of different power levels, while controlling the radiation power in dependence of a sampled sense signal.

The invention further relates to a method of adapting generating a sampled sense signal in the device.

A device and method for recording an optical record carrier are known from US 2005/0083828. A high-speed optical disc recording apparatus includes a laser diode for generating multi-pulse radiation and a photodiode outputting a sense signal indicative of the power of the radiation. An encoder generates a sequence of control periods of different lengths, each control period having one of a number of different power levels, while controlling the radiation power in dependence of a sampled sense signal. For calibrating the sampled sense signal the device provides a power control pattern according to a write strategy to a laser diode driver such that the laser diode outputs a multi-pulse having a fixed-duty ratio with two power levels. The measured power is averaged with a low-pass filter, is sampled and held, and is calibrated according to the fixed-duty ratio. The calibrated held average output of the measured power of the light pulses is compared with predetermined levels to control the laser diode driver output voltage. However, applying a dedicated power control pattern requires an area on the record carrier and a startup time available for calibration. Furthermore, the calibration based on averaging the sense signal appears to be inaccurate, and may in particular be dependent on operational conditions.

Therefore it is an object of the invention to provide a device and method for reliably generating a sampled sense signal in various operational conditions.

According to a first aspect of the invention the object is achieved with a device for recording information as described in the opening paragraph, the devices comprising sense means for generating the sampled sense signal by sampling the sense signal at a sampling time Ts in selected control periods that are selected on having at least a selected minimum length Lsel, Ts being located in a part of the selected control periods starting at Lsel, for determining a first sample value, further sampling the sense signal in the selected control periods for determining a second sample value on a detection time Tdet different from Ts in the selected control periods, determining a difference between the first and the second sample value and, in dependence on the difference, adapting said generating the sampled sense signal.

According to a second aspect of the invention the object is achieved with a method for generating a sense signal as described in the opening paragraph, which method comprises sampling the sense signal at a sampling time Ts in selected control periods that are selected on having at least a selected minimum length Lsel, Ts being located in a part of the selected control periods starting at Lsel, for determining a first sample value, further sampling the sense signal in the selected control periods for determining a second sample value on a detection time Tdet different from Ts in the selected control periods, determining a difference between the first and the second sample value and, in dependence on the difference, adapting said generating the sampled sense signal.

The effect of the measures is that the first and second sample value are sampled in selected control periods in the sequence that controls the radiation source, usually a multi-pulse drive signal for a laser diode. The control periods for sampling are selected to have at least the minimum length Lsel. By sampling beyond Lsel in the selected control periods, the sense signal has sufficiently stabilized to be reliably sampled. By determining the difference between two sample values taken at different instants in the selected control period it can be detected if transitory effects from applying a different, e.g. much higher, power level in the preceding control period have sufficiently decayed before the samples are taken, or remaining effects can be taken into account for adapting the generating of the sampled sense signal. Advantageously, such sampled sense signal is accurately representing the power of the radiation beam, and may be generated at any time, e.g. during operationally recording of data.

The invention is also based on the following recognition. As writing speed in various optical recording systems increases, the time intervals in the write strategy for various power levels become shorter. Traditionally, for multi-pulse write strategies, even at relatively low speeds, only the erase level can be sampled, but high speed recording using a blue laser, which also uses multi-pulse strategies, will have such short erase levels that sampling becomes very difficult and/or very expensive.

The inventors have seen that, when the selecting the longer control periods, samples can be taken in a relatively stable end part of such selected periods. However, in modern systems taking into account all possible sources of disturbance only the longest marks might be selected, which would very much limit the amount of sampled values and hence the reliability of the sampled sense signal, or might even require a dedicated calibration procedure. By detecting the difference between the first and second sample and monitoring the difference, and dynamically adapting the generation of the sampled sense signal, remaining instability and transitory effects can be taken into account based on a sufficient number of samples during operational use.

In an embodiment of the device the sense means are arranged for adapting Lsel in dependence on the difference. By adapting Lsel the selection of selected control periods is adapted to select only the periods having sufficient length and stability for reliably sampling the sense signal while the stability is monitored by the difference. This has the advantage that the selection is adapted to the operational conditions which affect the difference.

In an embodiment of the device the sense means are arranged for increasing Lsel until the difference is below a predetermined threshold value, in a particular case until the difference is less than 1% of the first or second sample value.

The difference between the first and second sample is indicative of the stability of the sense signal representing the detected power level. Applying the threshold while increasing Tsel has the advantage that the stability is controlled to be at a predetermined level, while allowing sampling during any interval that fulfills the stability requirement.

In an embodiment, on the record carrier the marks in the track have lengths corresponding to an integer number of channel bit lengths T, the shortest marks having a length of a predefined minimum number Lmin of channel bit lengths T, and the sense means are arranged for adapting Lsel to a value larger than Lmin. In particular the marks may be selected that are created by selecting the selected control periods having a read power level or an erase power level. This has the advantage that control periods having a relatively large length are easily selected by monitoring the marks to be written.

In an embodiment of the device the sense means comprise processing means for generating the sampled sense signal in dependence of at least one correction parameter, and are arranged for determining the at least one correction parameter in dependence of the difference. By sampling the sense signal on two or more sample times in the selected control period, the way the sense signal varies can be detected. Advantageously a model of the transfer function of the sensor having one or more correction parameters may be used to apply when processing the sample values for accurately generating the sampled sense signal.

Further preferred embodiments of the device and method according to the invention are given in the appended claims, disclosure of which is incorporated herein by reference.

These and other aspects of the invention will be apparent from and elucidated further with reference to the embodiments described by way of example in the following description and with reference to the accompanying drawings, in which

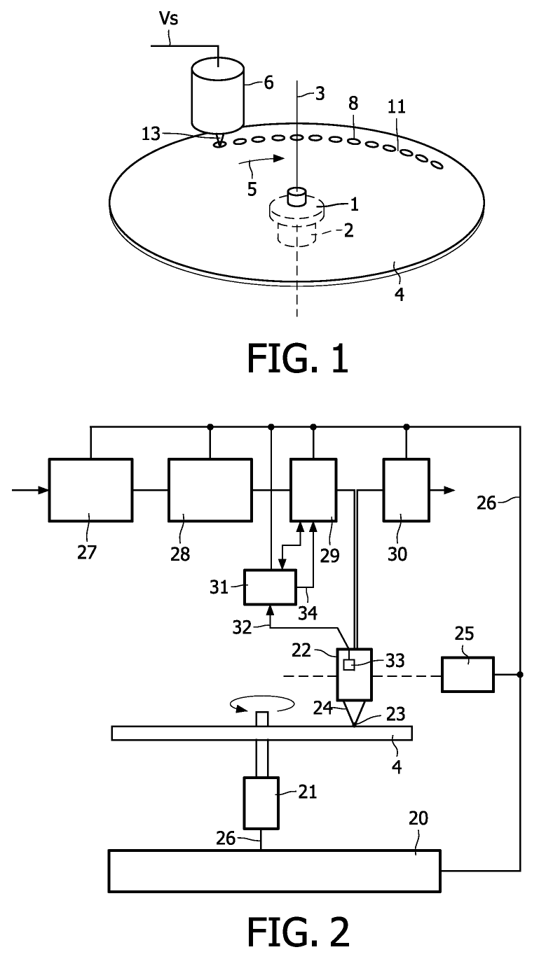

FIG. 1 shows an optical recording process in a scanning device,

FIG. 2 shows a recording device having sense signal generation,

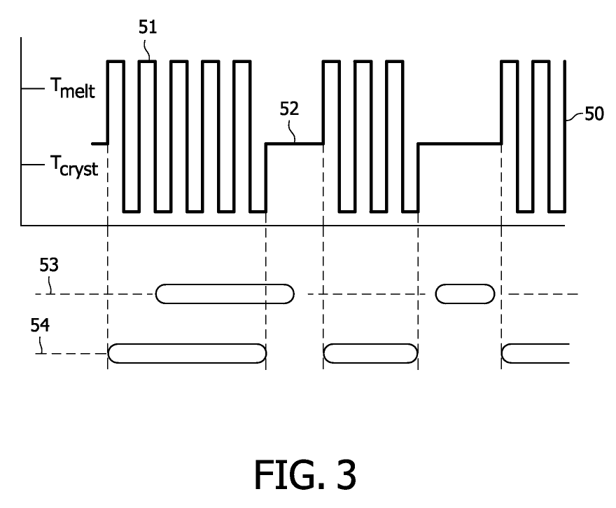

FIG. 3 shows a relationship between recorded data marks and an associated power control signal,

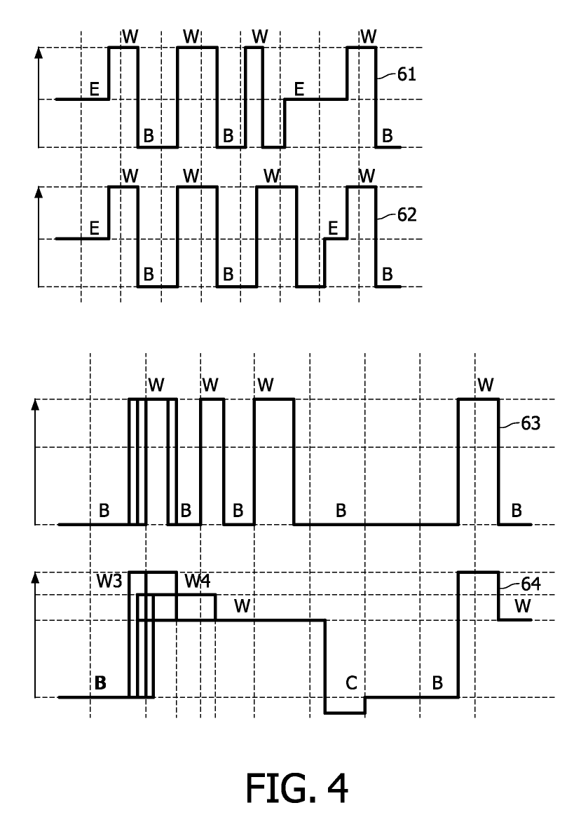

FIG. 4 shows examples of write strategies for high speed recording,

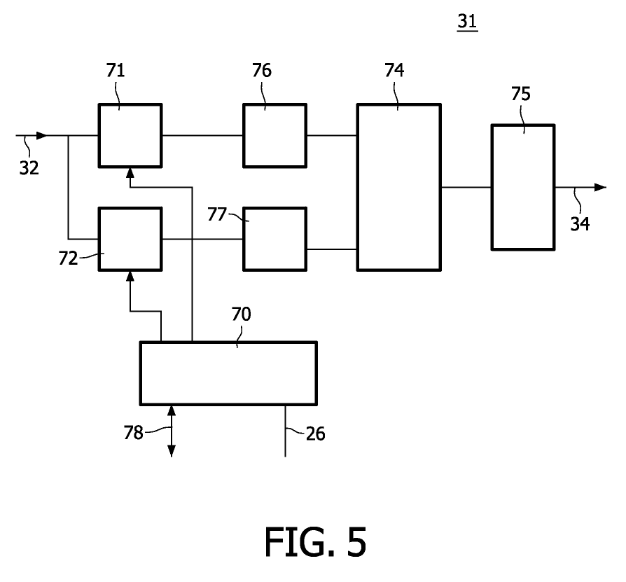

FIG. 5 shows generating a sampled sense signal, and

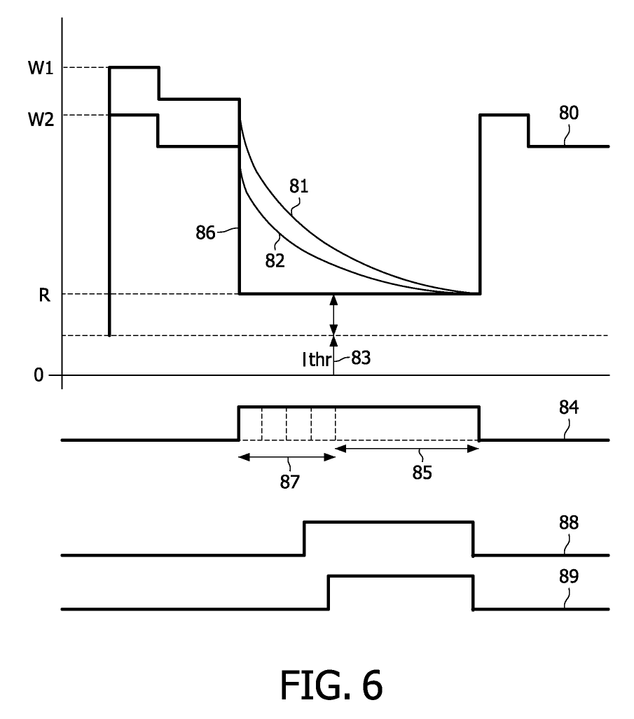

FIG. 6 shows a slow tail in a sense signal and selective sampling.

In the Figures, elements which correspond to elements already described have the same reference numerals.

FIG. 1 shows an optical recording process in a scanning device. The scanning device comprises a turntable 1 and a drive motor 2 for rotating a disc shaped record carrier 4 about an axis 3 in a direction indicated by an arrow 5, and an optical write head 6.

The record carrier 4 comprises a radiation-sensitive recording layer which upon exposure to radiation of sufficiently high intensity is subjected to an optically detectable change, such as for example a change in reflectivity, for forming marks 8 representing information in a track 11. The track 11 may be indicated by a servo pattern for generating servo tracking signals for positioning an optical head opposite the track. The servo pattern may for example be a shallow wobbled groove, usually called a pre-groove, and/or a pattern of indentations, usually called pre-pits or servo pits.

The optical write head 6 is arranged opposite the rotating record carrier. The optical write head 6 comprises a radiation source, for example a solid-state laser, for generating a write beam 13. The intensity I of the write beam 13 can be modulated in conformity with a control signal Vs in a customary manner. The intensity I of the write beam 13 varies between a write intensity Iw, which is adequate to bring about detectable changes in the optical properties of the radiation-sensitive record carrier, and an intensity In for producing spaces.

The marks may be in any optically readable form, e.g. in the form of areas with a reflection coefficient different from their surroundings, obtained when recording in materials such as dye, alloy or phase change material, or in the form of areas with a direction of polarization different from their surroundings, obtained when recording in magneto-optical material.

During scanning a beam reflected from the record carrier is modulated in conformity with the information pattern being scanned. The modulation of the read beam can be detected in a customary manner by means of a radiation-sensitive detector which generates a read signal which is indicative of the beam modulation.

User data can be recorded on the record carrier by marks having discrete lengths in unit called channel bits, for example according to the CD or DVD channel coding scheme. The marks are having lengths corresponding to an integer number of channel bit lengths T. The shortest marks that are used have a length of a predefined minimum number d of channel bit lengths T for being detectable via the scanning spot on the track that has an effective diameter, usually being roughly equal to the length of the shortest mark.

FIG. 2 shows a recording device having sense signal generation. The device is provided with means for scanning a track on a record carrier 11 which means include a drive unit 21 for rotating the record carrier 11, a head 22, a servo unit 25 for positioning the head 22 on the track, and a control unit 20. The head 22 comprises an optical system of a known type for generating a radiation beam 24 guided through optical elements focused to a radiation spot 23 on a track of the information layer of the record carrier. The radiation beam 24 is generated by a radiation source, e.g. a laser diode. The optical head 22 comprises a sensor 33, usually called a forward sense diode or monitor diode, for detecting a sense signal 32 from the radiation beam. The head further comprises a focus actuator (not shown) for moving the focus of the radiation beam 24 along the optical axis of said beam and a tracking actuator (not shown) for fine positioning of the spot 23 in a radial direction on the center of the track. The focus and tracking actuators are driven by actuator signals from the servo unit 25.

For reading the radiation reflected by the data layer is detected by a detector of a usual type, e.g. a four-quadrant diode, in the head 22 for generating detector signals to be processed by read processing unit 30 of a usual type including a demodulator, deformatter and output unit to retrieve the information.

For writing the device is provided with recording means for recording information on a record carrier of a writable or re-writable type, for example CD-R or CD-RW, or DVD+RW or BD. The recording means cooperate with the head 22 for generating a write beam of radiation, and comprise write processing means for processing input information to generate a write signal to drive the head 22, which write processing means comprise an input unit 27, a formatter 28 and a power control unit 29. The power control unit 29 controls the power of a radiation source, usually a laser, in the head 22 to create optically detectable marks in the recording layer.

The control unit 20 controls the scanning and retrieving of information and may be arranged for receiving commands from a user or from a host computer. The control unit 20 is connected via control lines 26, e.g. a system bus, to the other units in the device. The control unit 20 comprises control circuitry, for example a microprocessor, a program memory and interfaces for performing the procedures and functions as described below. The control unit 20 may also be implemented as a state machine in logic circuits. It is noted that the focus adjustment functions as described below may also be implemented as software functions in the control unit 20.

The input unit 27 may comprise compression means for input signals such as analog audio and/or video, or digital uncompressed audio/video. Suitable compression means are described for video in the MPEG standards, MPEG-1 is defined in ISO/IEC 11172 and MPEG-2 is defined in ISO/IEC 13818. The input signal may alternatively be already encoded according to such standards.

In an embodiment the recording device is a storage system only, e.g. an optical disc drive for use in a computer. The control unit 20 is arranged to communicate with a processing unit in the host computer system via a standardized interface. Digital data is interfaced to the formatter 28 and the read processing unit 30 directly.

In an embodiment the device is arranged as a stand alone unit, for example a video recording apparatus for consumer use. The control unit 20, or an additional host control unit included in the device, is arranged to be controlled directly by the user, e.g. to perform the functions of a file management system.

The power control unit 29 drives the radiation source by a power control signal. The laser is driven using a pulse sequence that contains higher frequency components that the channel rate itself. This has the form of a multi-level pulse whose purpose is to achieve a “mark” or a “space” of a given length of the optical medium so that it matches encoded data from the encoder in formatter 28. The conversion of encoded data to a pulse-train with higher time resolution and multiple levels is known as a Write Strategy. Thereto the power control unit 29 generates a sequence of control periods of different lengths, each control period having one of a number of different power levels, according to the write strategy. Usually the write strategy is adapted for the type of record carrier and the recording speed. For controlling the radiation power to each of the desired power levels the power control unit 29 receives a sampled sense signal 34 that is based on the sense signal 32.

FIG. 3 shows a relationship between recorded data marks and an associated power control signal. A power control signal 50 is according to a multi-pulse write strategy which directly writes over existing data. On the vertical axis a temperature Tmelt is indicated corresponding to a radiation power at which the recording material in the data layer melts, and a temperature Tcryst corresponding to a radiation power at which the recording material in the data layer crystallizes. An upper track 53 shows some old data marks that are to be erased by an erase power level 52, whereas the lower track 54 shows new marks after writing corresponding to the pulsed parts 51 at the write power level.

FIG. 4 shows examples of write strategies for high speed recording. It is noted that other write strategies are known for other media and writing speeds. The first curve shows a first power control signal 61 for a rewritable type of record carrier like CD-RW at 24× nominal speed or DVD+RW at 8× nominal speed. The vertical dashed lines indicate the channel bit timing. An erase power level E, a write power level W and a low power level B, for example a reading power level, are used, while levels may change at double the speed of the channel bits, usually called a 2T write strategy. The first power control signal 61 indicates the pulsed sequence for writing a mark of a length of 7 channel bits (17).

The second curve shows a second power control signal 62 for the same rewritable type of record carrier, and indicates the pulsed sequence for writing a mark of 8 channel bits (18).

The third curve shows a third power control signal 63 for a write once type of record carrier like DVD+R at 2.4× nominal speed. The power levels change at even higher time resolution. The fourth curve shows a fourth power control signal 64 for a further write once type of record carrier like DVD-R or DVD+R up to 16× nominal speed. Note that further power levels C, W3 and W4 are used.

For performing the various write strategies for the power control signals shown in FIGS. 3 and 4 there is a need for a sense signal that accurately indicates the actual power of the radiation source. Thereto the device further comprises a sense unit 31 for generating a sampled sense signal 34 indicative of the power of the radiation beam. The sense signal 32 is input to the sense unit 31. The sampled sense signal 34 is connected to the power control unit 29 for controlling the radiation source to a desired power level. The control unit 20 may communicate with the sense unit 31 and other units for performing a calibration of the sampled sense signal generation functions as discussed in detail below.

The sense unit 31 generates the sampled sense signal as follows. The sense signal is sampled at a sampling time Ts in selected control periods that are selected on having at least a selected minimum length Lsel. The sampling time Ts is located in a part of the selected control periods starting at Lsel, for determining a first sample value. Furthermore the sense signal is sampled in the selected control periods for determining a second sample value on a detection time Tdet different from Ts in the selected control periods. Preferably the first and second sample values are taken from the same selected control periods. Subsequently a difference is determined between the first and the second sample values. Because the first and the second sample values have a predetermined difference in time, the difference between the sample values indicates the stability of the sense signal. It is to be noted that in a selected period the radiation power is assumed to be stable at a single, desired power level. Therefore, ideally, the sense signal should also be stable. However, due to noise and, in particular, due to known sources of disturbance, the sense signal will only become sufficiently stable at the end of a relatively long control period in the sequence, as discussed below in detail. Finally, the sense unit adapts the generating of the sampled sense signal in dependence on the detected difference.

FIG. 5 shows generating a sampled sense signal. The sense unit 31 receives the sense signal 32 from the sensor via a (variable) input amplifier (if present). In a sample unit 71 samples are taken under the control of timing unit 70. The samples may be converted into digital sample values, which are coupled to difference unit 74 for determining a difference. Processing unit 75 receives the difference, and the sample values, and generates the sampled sense signal. The sense unit may have a second sample unit 72 for taking a second sample at a different instant in the selected periods, or the second samples may be taken by the first sample unit 71. The timing unit is arranged for selecting the sample instants for the first and second samples in selected periods of at least a minimum length Lsel, in the end part of such selected periods. Thereto the timing unit may receive control data 78 from the power control unit 29 indicating the lengths of periods having a same power level, and may further communicate via control lines 26 to the control unit 20.

In an embodiment of the device, the sense unit 31 is arranged for adapting the minimum length Lsel in dependence on the difference as detected by difference unit 74. For example Lsel may be set to a value in dependence of the type of the record carrier that is actually present in the device. Subsequently the difference is detected, and the value for Lsel may be adapted to a lower value as long as the difference remains small. Also the sense unit 31 may be arranged for increasing Lsel until the difference is below a predetermined threshold value. In a practical example Lsel may be increased until the difference is less than 1% of the first or second sample value.

Usually, on the record carrier, the marks in the track have lengths corresponding to an integer number of channel bit lengths T, while the shortest marks have a length of a predefined minimum number Lmin of channel bit lengths T. Lmin for CD and DVD is 3 channel bits, while the maximum length Lmax of the marks is usually 11 to 14. The sense unit 31 may be arranged for adapting Lsel to a value substantially larger than Lmin, but smaller than Lmax, for example between 8 and 10.

As can be seen from the write strategies in FIGS. 3 and 4, the longer periods having a same power level occur at read or erase power. Thereto the sense unit 31 may be arranged for selecting the selected control periods having a read power level or an erase power level. It is noted that the sense unit may be arranged for generating sampled sense signals at different power levels, for example at an erase power and also at a write power, if such write power is available in a sufficiently long control period in the sequence. It is noted that sampling at different power levels may require a different minimum selection length for each level, because the effects of the slow tail depend on the level and the difference with preceding power levels

The sense unit may comprise an averaging unit 76, and a further averaging unit 77, for determining the first and/or second sample value based on a sequence of sample values of the sense signal. By such averaging units, well known as such and for example including integration or summation of large numbers of samples, the effective resolution of digital sampled values, which in practice at the input may be 5 or 6 bits, can be increased to 10 or 12 bits.

The actual power control may be carried out using the sampled level with required sampling start delay, based on the averaged sample signal in either unit 76 or 77 as the radiation power feedback signal. In addition, the difference signal from unit 74 or the processed difference signal from unit 75 can be used to correct either the light power feedback signal or the power setpoint signal /value and in so doing eliminate or reduce the influence of the remaining “slow-tail” in the laser power control loop.

The sense unit 31 has the following purpose. High speed, multi-pulse write strategies have such short erase levels that direct sampling becomes very difficult and/or very expensive. This is because the time available for the amplifier of the forward sense (FS) signal to settle becomes shorter which implies either special FS design and/or very fast amplifiers are required in combination with higher gains as the laser wavelength decreases from CD to DVD to BD. Also the sense diode may be inherently slow. The speed of the sense diode may depend on the wavelength of the radiation and the depth the radiation penetrates into the semi-conductive layers. For example, lower wavelength red or infra-red radiation will penetrate deeper, and may reach the depletion layer of the FS diode, which reduces the response speed. The settling effect to a new sense level, which succeeds a higher sense level in a preceding period, is called the FS “slow-tail”. It is noted that in particular for a low level (e.g. read power level in write-once recording) following a high write level the slow tail is relatively strong with respect to the sense level to be detected.

In an embodiment of the sense unit 31 the processing unit 75 is arranged for generating the sampled sense signal in dependence of at least one correction parameter. The sense unit 31 is arranged for determining the at least one correction parameter in dependence of the difference. A correction parameter may be a slope of a decaying effect (slow tail) that is present in the sense signal due to a (higher) power level in a preceding period. The slope may be calculated from the two samples taken at different instants in time. A more complex model having several correction parameters may be implemented also, while a resulting curve from the model may be fitted based on two or more sample values. Further examples for a model of the sense process are, for example, described in US 2005/0083828 mentioned in the introductory part.

FIG. 6 shows a slow tail in a sense signal and selective sampling. A graph shows the sense signal 80 from a forward sense diode. The signal corresponds to a power control signal 86 driving a laser, when adding a threshold current 83 needed by the laser to start generating laser light. The pulse sequence of the power control signal includes write power levels W1 and W2, and a read power level R. Sampling of the sense signal is to take place in the relatively long period of the read level. Signal 84 indicates the corresponding mark to be created by the radiation. The mark has an initial part (indicating channel bits by dashed lines) during which sampling is blocked. Marks of shorter than the minimum selection length Lsel 87 are rejected for sampling. The current mark is exceeds Lsel and is selected for sampling in the end part 85 of the period of read level in the power control signal. A first sample interval 88 starts at Lsel, whereas a second sample interval 89 starts at Lsel+1.

In this invention, the issue of how to set the minimum selection length Lsel for FS sampling is addressed. The current system, which dynamically adjusts the generation of the sampled sense signal, does take the behavior of individual drives into account (eg FS path gain spreads). In a calibration procedure the difference in sampled FS output between sampling with N channel periods run length rejection and N+1 channel periods run-length rejection is measured for N=0,1,2 . . . as shown in bottom traces 88,89 in FIG. 6, until the difference is seen to be less than a given tolerance (say 1% of the measured value). This value of N is then chosen as the minimum selection length Lsel. This calibration may be done once in the factory to set an Lsel value in a memory. The calibration may also be performed in the field, e.g. when inserting a new record carrier in the device.

During operational use, after initially setting the minimum selection length Lsel, in order to maintain accurate power control only an N−1 (or N+1) to N comparison is required. For example, the value of N−1 or N+1 can be maintained on a second (parallel) sample channel as check.

Furthermore, the difference of the first and second sample value at a known distance in the selected periods can be used to calculate the power scaling effect on FS. Thereto further parameters, such as a known difference for a given starting power, are to be determined and taken into account in a model of the sense channel. A calculating based on a model of the slow tail, the known power in the preceding period and the sample values in the current period allow correction of the sample sense signal by subtracting the remaining slow tail contribution. The model may also depend on the radiation source or the wavelength, or on type of the record carrier or the recording layer that is actually scanned, which may affect the operation of the sense channel. The disc type may be detected from disc information retrieved from the record carrier, e.g. a prerecorded area or from a modulated, wobbled pregroove.

It is noted, that in this document the word ‘comprising’ does not exclude the presence of other elements or steps than those listed and the word ‘a’ or ‘an’ preceding an element does not exclude the presence of a plurality of such elements, that any reference signs do not limit the scope of the claims, that the invention may be implemented by means of both hardware and software, and that several ‘means’ or ‘units’ may be represented by the same item of hardware or software. Further, the invention is not limited to the embodiments, and the lies in each and every novel feature or combination of features described above.

1. Device for scanning a record carrier (4) having a track (11) for recording information represented by marks (8), the device comprising:
scanning means (22) comprising a radiation source and optical elements for generating a beam of radiation from the radiation source via a scanning spot on the track to a detector for detecting at least one scanning signal,
a sensor (33) for generating a sense signal (32) from the beam (24),
power control means (29) for setting the radiation power in a sequence of control periods of different lengths, each control period having one of a number of different power levels, while controlling the radiation power in dependence of a sampled sense signal, and
sense means (31) for generating the sampled sense signal by
sampling the sense signal at a sampling time Ts in selected control periods that are selected on having at least a selected minimum length Lsel, Ts being located in a part of the selected control periods starting at Lsel, for determining a first sample value,
further sampling the sense signal in the selected control periods for determining a second sample value on a detection time Tdet different from Ts in the selected control periods,
determining a difference between the first and the second sample value,
and, in dependence on the difference, adapting said generating the sampled sense signal.

2. Device as claimed in claim 1, wherein the sense means (31) are arranged for adapting Lsel in dependence on the difference

3. Device as claimed in claim 2, wherein the sense means (31) are arranged for increasing Lsel until the difference is below a predetermined threshold value, in a particular case until the difference is less than 1% of the first or second sample value.

4. Device as claimed in claim 2, wherein, on the record carrier, the marks in the track have lengths corresponding to an integer number of channel bit lengths T, the shortest marks having a length of a predefined minimum number Lmin of channel bit lengths T, and
the sense means (31) are arranged for adapting Lsel to a value larger than Lmin.

5. Device as claimed in claim 1, wherein the sense means (31) are arranged for selecting the selected control periods having a read power level or an erase power level.

6. Device as claimed in claim 1, wherein the sense means (31) comprise processing means for generating the sampled sense signal in dependence of at least one correction parameter, and are arranged for determining the at least one correction parameter in dependence of the difference.

7. Device as claimed in claim 1, wherein the sense means (31) comprise averaging means for determining the first and/or second sample value based on a sequence of sample values of the sense signal.

8. Method of adapting generating a sampled sense signal in a device for scanning a record carrier (4) having a track (11) for recording information represented by marks (8), the device comprising:
scanning means (22) comprising a radiation source and optical elements for generating a beam of radiation from the radiation source via a scanning spot on the track to a detector for detecting at least one scanning signal,
a sensor (33) for generating a sense signal (32) from the beam (24),
power control means (29) for setting the radiation power in a sequence of control periods of different lengths, each control period having one of a number of different power levels, while controlling the radiation power in dependence of a sampled sense signal, the method comprising
sampling the sense signal at a sampling time Ts in selected control periods that are selected on having at least a selected minimum length Lsel, Ts being located in a part of the selected control periods starting at Lsel, for determining a first sample value,
further sampling the sense signal in the selected control periods for determining a second sample value on a detection time Tdet different from Ts in the selected control periods,
determining a difference between the first and the second sample value,
and, in dependence on the difference, adapting said generating the sampled sense signal.

9. Method as claimed in claim 8, wherein the method comprises adapting Lsel in dependence on the difference.
